(19) United States
(12) Patent Application Publication
(10) Pub. No.: US 2006/0214327 A1
(43) Pub. Date: Sep. 28, 2006

(54) IN-MOLD DECORATION FABRICATION OF INJECTION MOLDING

(76) Inventors: Chuan-Shien Yu, Taipei City (TW); Lu-Chin Wu, Taipei County (TW); Dean-Kuo Liu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/160,324

(22) Filed: Jun. 20, 2005

(30) Foreign Application Priority Data
Mar. 22, 2005 (TW) 94108742

(51) Int. Cl. B29C 45/14

(52) U.S. Cl. 264/279; 264/255; 264/132; 264/160; 264/153; 264/544

(57) ABSTRACT

An in-mold decoration fabrication of injection molding is provided as following: first, a plastic substrate is provided to perform a step of forming to form a geometric shape and/or 3D shape of a specific product on the plastic substrate; second, a patterned metal film is formed on the geometric shape of the specific product, and then an ink pattern is further formed on the patterned metal film selectively; next, a step of trimming is provided to cut the plastic substrate into a plurality of forming units; finally, a step of resin injection is provided to cover the patterned metal film, ink pattern of each of the forming units and the exposed surface thereof.

### CROSS-REFERENCE TO RELATED APPLICATION

This application claims the priority benefit of Taiwan application serial no. 94108742, filed on Mar. 22, 2005. All disclosure of the Taiwan application is incorporated herein by reference.

### BACKGROUND OF THE INVENTION

1. Field of Invention

The present invention relates to a method of injection molding. More particularly, the present invention relates to an in-mold decoration (IMD) fabrication of injection molding.

2. Description of Related Art

The conventional in-mold decoration injection technology includes the fabrication processes of ink printing, pre-forming, trimming and resin injection. In accordance with different kinds and characteristics of the film material, by the assistant work using injection molding tools of pre-forming, trimming and injection, these processes can produce the structure members of consumption electronic products such as computer and communication, inner decoration and information appliance.

Generally, the surface of products made by the in-mold decoration injection technology has a layer of transparent plastic film to protect the under laid ink printing pattern from scratching and fading. Therefore, the conventional fabrication processes such as spray-painting process, pad printing process, water transferring process, bronzing process or multi-color with multi-material injection process are gradually replaced by the aforementioned in-mold decoration injection technology.

Accordingly, if the injection products require a coating with the sense of metal quality, a metal coating process is necessary before the ink printing process. This includes following steps: first, a metal film is formed wholly on a plastic substrate; then, the metal film is etched in order to remove the unwanted metal film outside the pattern; next, a needed ink pattern is printed with a screen on the patterned metal film; then, after drying the ink pattern, the steps of pre-forming, trimming and resin injection are performed to accomplish the in-mold decoration injection products.

It should be noticed that the appearances of the injection products depends on a proper match between the coefficients of thermal expansion of the forming molds and the plastic substrates. Only when the coefficients of thermal expansion are properly matched, the frames can be made without wrinkles at the rims and with even wrappings. Especially to window products with metal frames, it has been limited by molding condition. The pre-forming process is incapable of effectively making the intended hem angles so that the wrinkles at the rims of the frames and uneven wrappings become the obvious defects that result in the loss of their excellent original sense of quality. Therefore, the present invention is to provide a way on providing the steps of the fabrication process to overcome aforementioned defects.

### SUMMARY OF THE INVENTION

Accordingly, an objective of the present invention is to provide a method of in-mold decoration fabrication of injection molding by improving the pre-forming process so as to improve the quality of injection products.

The present invention is directed to provide a method of in-mold decoration fabrication of injection molding that includes the steps as follows. First, a plastic substrate is provided and a pre-forming process is performed to form a geometric shape of a specific product on the plastic substrate. Next, a patterned metal film is formed on the geometric shape of the specific product. Next, an ink pattern is selectively formed on the patterned metal film. Then, a trimming process is performed to cut the plastic substrate into a plurality of forming units. Finally, a step of resin injection is performed to cover the patterned metal film, the ink pattern and the exposed surface of each forming unit.

According to the preferred embodiment of the present invention, the aforementioned forming process includes, exemplarily, punch shaping the plastic substrate or vacuum shaping the plastic substrate.

According to the preferred embodiment of the present invention, the process of aforementioned patterning metal films is, for example, first, forming a metal film on the surface of the pre-formed plastic substrate; then, removing the unwanted metal film by lithographing and etching processes; then, a patterned metal film is formed on the geometric shape of the specific product. Besides, the process of patterning metal film can also be, first, disposing a mask on a surface of the pre-formed plastic substrate; then, forming a metal film on the surface of the geometric shape of the specific product and the mask; and then, removing the mask to form a patterned metal film on the geometric shape of the specific product.

According to the preferred embodiment of the present invention, the aforementioned method of forming the metal films includes Chemical Vapor Deposition (CVD) process or Physical Vapor Deposition (PVD) process.

According to the preferred embodiment of the present invention, the aforementioned method of forming the ink patterns includes a screen printing process.

According to the preferred embodiment of the present invention, the aforementioned geometric shape of the specific product includes, exemplarily, a plurality of protruding parts. Two contiguous protruding parts exemplarily connect to each other to form a frame. The area surrounded by the frame is a transparent window. Besides, the patterned metal film can cover the surface of each frame and its wrapping.

The method of the present invention is that, after the step of the pre-forming, the steps of patterning the metal film, trimming and resin injection are performed in sequence. Therefore, the defects caused from the step of pre-forming process, such as the wrinkles at the rims of the frame or uneven wrappings, can be covered by the patterned metal film without appearance, so that the quality of the injection product can be improved and its excellent original sense of quality can be fully presented.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a drawing, schematically illustrating the flow chart, indicating an in-mold decoration fabrication of injection molding, according to the preferred embodiment of the present invention.

FIG. 2 to FIG. 6 are cross-sectional views, schematically illustrating the processes in FIG. 1.

### DESCRIPTION OF EMBODIEMNT

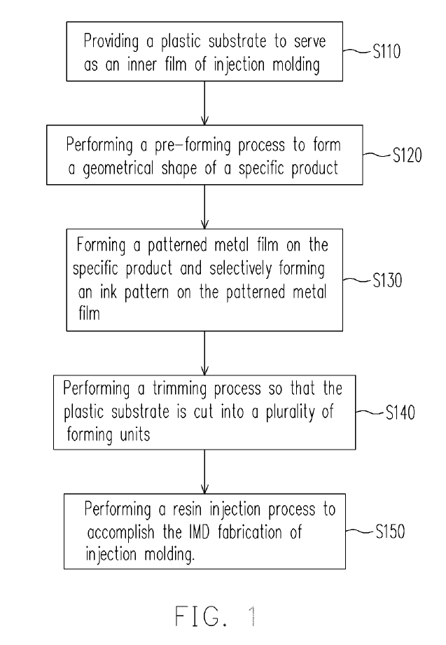

FIG. 1 is a schematic flow chart illustrating an in-mold decoration (IMD) fabrication of injection molding according to a preferred embodiment of the present invention, while FIG. 2 to FIG. 6 are the cross-sectional drawings corresponding to the steps indicated in FIG. 1. In FIG. 1, the process of IMD fabrication of injection molding includes the steps as follows. Step S110, a plastic substrate is provided as an inner film of injection molding. Step S120, a pre-forming process is performed to form a geometrical shape of a special product. Step S130, a patterned metal film is formed on the geometric shape of the specific product and an ink pattern is selectively formed on the patterned metal film. Step S140, a trimming process is performed so that the plastic substrate is cut into a plurality of forming units. Step S150, a resin injection process is performed to accomplish the IMD fabrication of injection molding.

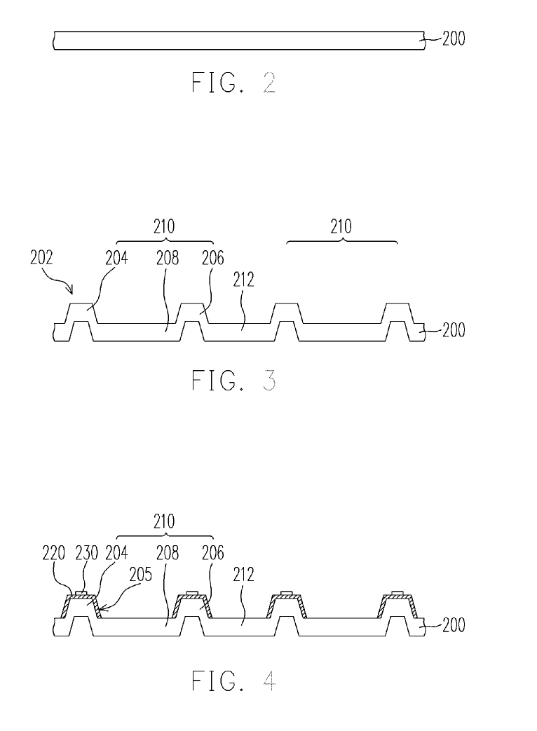

As illustrated in FIG. 2 and FIG. 3, the plastic substrate 200 provided in Step S110 is exemplarily a transparent film with a thickness of few hundreds microns. The transparent film usually has the component of thermoplastic polymer or ester etc. By proper vacuum heating and pressuring in the pre-forming mold (not illustrated), the plastic substrate 200 can be formed into the intended geometric shape of the specific product 202, for example, a plurality of protruding parts 204 and 206 on the surface of the plastic substrate 200. As showed in FIG. 3, there is an even part 208 between these protruding parts 204 and 206. Taking the manufacture of the window frames as the example, two contiguous protruding parts 204 and 206, together with an even part 208, can form a window frame 210, in which the two contiguous protruding parts 204 and 206 connect to each other and surround the even part 208. Thus the even part 208 forming the transparent window. This kind of window frame 210 structure can be used for liquid crystal displays, touch-sensitive displays or lens protecting frames.

Following the foregoing descriptions, in the preferred embodiment of the present invention, between two contiguous window frames 210 there is a concave part 212 acting as a dividing area. In the following fabrication process, the concave part 212 will be cut away and only the divided window frames 210 remain, that are also called ‘forming units’. Then, in Step S150, a resin injection can be performed. In addition, although the foregoing descriptions take the window frame 210 as the illustration, the geometric shape of the specific product 202 is not limited to the frame shape, and can be either the protruding segmental line or other shapes.

Next, in Step S130 as shown in FIG. 4, the technologies of sputtering deposition or vapor deposition, such as Physical Vapor Deposition (PVD) process or Chemical Vapor Deposition (CVD) process can be used to form a patterned metal film 220 on the intended geometric shape of the specific product 202. The thickness of the patterned metal film 220 can be adjusted according to the condition of fabrication process. Remarkably, because the patterned metal film 220 can be deposited on the intended geometric shape of the specific product 202, for example, on the top surface and the wrapping 205 of the protruding parts 204 and 206, its thickness can properly cover the defects caused from the pre-forming molds. Especially, the defects of the wrinkles occurring at the peripheral region of the protruding parts 204 and 206, that is, the window frame 210, and the uneven wrapping 205 can be solved by obtaining a planarization effect resulting from the deposited metal. The defects become inconspicuous, so that the original sense of quality of the deposited patterned metal film 220 can be kept and the product quality can be improved.

In the preferred embodiment of the present invention, there are several methods to form the patterned metal film 220. Herein, two preferred examples are taken for the further illustration. With the first method, a metal film 220 is formed wholly on the surface of the pre-formed plastic substrate 200. Then, the unwanted portion of the metal film is removed by lithographing and etching processes. Then, a patterned metal film 220 is formed on the geometric shape of the specific product 202. In the second method, a mask (not illustrated) is disposed on the surface of the pre-formed plastic substrate 200. Then, a metal film 220 is formed on the geometrical shape of the specific product 202 and the surface of the mask. Then, the mask is removed so that a patterned metal film 220 is formed on the geometrical shape of the specific product 202. The manufacture of a window frame 210 is taken as illustration, the second method is preferably taken to cover the transparent window with the mask, so as to keep the etchant from etching the transparent window and consequently reducing the product quality.

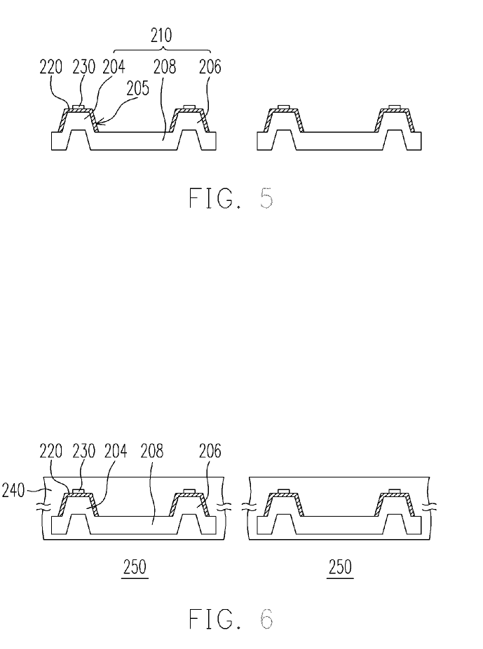

Next, in Step S130 as illustrated in FIG. 5, an ink pattern 230 is formed by a screen printing process (not illustrated) exemplarily. The ink pattern 230 can be in accordance with the metal film 220 of the window frame 210, and produce various decorative patterns to present the sense of high quality. Certainly, the formation of the ink pattern 230 is not limited to the screen printing process. The ink pattern 230 can also be formed the transfer printing process or other equivalent methods. After the ink pattern 230 is dried by baking, a process of trimming is performed on the plastic substrate 200 in Step S140, to cut the plastic substrate 200 into a plurality of forming units respectively, for example, the aforementioned window frames 210.

Finally, as showed in FIG. 6, each forming unit is moved into injection molds (not illustrated) so that the resin injection process is performed in Step S150 to form the injection product of IMD 250. Wherein, the injection plastic 240 can cover the patterned metal film 220, the ink pattern 230 and the exposed surface of each forming unit, and after being cured, it can protect the ink pattern 230 from scratching and improve the product properties of impact-resisting and chemical-etch-resisting. Certainly, plastic or polymer with good light transparence is preferred when the injection plastic 240 is in choice.

Accordingly, the fabrication method of the present invention is that, after the pre-forming process, the steps of patterning metal film, trimming and resin injection are performed in sequence. Therefore, the defects caused from the step of pre-forming, such as the wrinkles at the rims of the frames or uneven wrappings, can be covered by the patterned metal film and is inconspicuous, so that the quality of injection product can be improved and its excellent original sense of quality can be fully preserved and presented.

In summary, the in-mold decoration fabrication of injection molding of the present invention has the following advantages:

(1) The defects caused from the forming process can be solved by the planarization effect resulting from the deposited metal film.

(2) The improved fabrication process can also keep the original sense of quality of the deposited metal film so as to improve the product quality.

The present invention is disclosed above with one of its preferred embodiment. It is to be understood that the preferred embodiment of present invention is not to be taken in a limiting sense. It will be apparent to those skilled in the art that various modifications and variations can be made to the structure of the present invention without departing from the scope or spirit of the invention. The protection scope of the present invention is in accordant with the scope of the following claims and their equivalents.

What is claimed is:

1. A method of in-mold decoration fabrication of injection molding, comprising:
providing a plastic substrate;
performing a pre-forming process, to form a geometric shape of a specific product on the plastic substrate;
forming a patterned metal film on the geometric shape of the specific product;
selectively forming an ink pattern on the patterned metal film;
performing a trimming process to cut the plastic substrate into a plurality of forming units; and
performing a resin injection process to cover the patterned metal film, the ink pattern of each of the forming units and an exposed surface of the forming units.

2. The method as claimed in claim 1, wherein a resin in the resin injection is a transparent material.

3. The method as claimed in claim 1, wherein the step of performing the pre-forming process comprises punching the plastic substrate or vacuum shaping the plastic substrate.

4. The method as claimed in claim 1, wherein the steps of forming the patterned metal film comprises:
forming a metal film on a surface of the pre-formed plastic substrate;
removing an unwanted portion of the metal film by lithographing and etching processes; and
forming the patterned metal film on the geometric shape of the specific product.

5. The method as claimed in claim 4, wherein the step of forming the metal film comprises performing Chemical Vapor Deposition (CVD) process or performing Physical Vapor Deposition (PVD) process.

6. The method as claimed in claim 1, wherein the step of forming the patterned metal film comprises:
disposing a mask on a surface of the pre-formed plastic substrate;
forming a metal film on a surface of the geometric shape of the specific product and the mask; and
removing the mask to form the patterned metal film on the geometric shape of the specific product.

7. The method as claimed in claim 6, wherein the method of forming the metal film comprises sputtering process or vapor deposition process.

8. The method as claimed in claim 1, wherein the step of forming the ink pattern comprises performing a screen printing process.

9. The method as claimed in claim 1, wherein the geometric shape of the specific product comprises a plurality of protruding parts.

10. The method as claimed in claim 9, wherein a planar part and a concave part formed between two of the contiguous protruding parts.

11. The method as claimed in claim 9, wherein two of the contiguous protruding parts connect to each other to form a frame, and a transparent window surrounded by the frame.

12. The method as claimed in claim 11, wherein the patterned metal film covers a top surface and a wrapping of each of the frames.

13. The method as claimed in claim 11, wherein the step of performing the trimming process comprises cutting the parts between the two contiguous frames so that each one of the forming units becomes a window frame respectively.

14. The method as claimed in claim 1, wherein a resin in the resin injection is a transparent material.
